(19) United States
(12) Patent Application Publication
(10) Pub. No.: US 2006/0134731 A1
(43) Pub. Date: Jun. 22, 2006

(54) Stain characterization for automated cytology

(76) Inventors: Louise Isenstein, Carlisle, MA (US); Patrick Foster, Wrentham, MA (US); Matthew Stroika, Wakefield, MA (US); Noorul Rahman, Ashland, MA (US)

Correspondence Address: CYTYC CORPORATION, 250 CAMPUS DRIVE, MARLBOROUGH, MA, 01752, US

(21) Appl. No.: 11/020,735

(22) Filed: Dec. 22, 2004

(51) Int. Cl. G01N 1/30

(52) U.S. Cl. 435/40.5

(57) ABSTRACT

A method is provided for analyzing and characterizing the formulation of a cell stain. In particular, the present invention provides a method of stain quality control using parameters derived from an imaging based automated cytology system to characterize the stain performance.

### FIELD OF THE INVENTION

A method is provided for analyzing and characterizing the formulation of a cell stain. In particular, the present invention provides a method of stain quality control (stain QC) using parameters derived from an imaging based automated cytology system to characterize the stain performance.

### A BACKGROUND OF THE INVENTION

Cytology generally refers to the study of the structure, function and pathology of cells. In a clinical laboratory environment cytotechnologists and pathologists diagnose a patient's condition by visually examining specimens of the patient's cells. These cells are typically stained to better define the structure of the cells and to aid in the visual review of the cells.

One common cytological technique is a pap smear, in which the cells from a woman's cervix are sampled and analyzed in order to detect the presence of abnormal cells. The process involves collecting a specimen from a woman's cervix using a brush or related instruments, and the specimen is then transferred to a slide for subsequent processing. The slide containing the specimen is then stained using on or more staining solutions and the slides are then coverslipped. The slide can then be evaluated visually by a cytotechnologist or by an automated imaging system.

One of the commonly used stains for cytological analyses is the Papanicolaou stain. The combination of dyes in the Papanicolaou stain gives the subtle range of green blue and pink hues to the cell cytoplasm according to the maturity level of the cells. Non-keratinized, normal superficial, and intermediate squamous cells are stained green and keratinized cells are orange to pink. Cancer cells are usually green in cytoplasm and stained blue in nuclei. In the period between the development of the Papanicolaou stain and the present day use a number of modifications have been made to the formulations of the stains involved.

The present invention relates to a means by which stain quality can be monitored for automated cytology applications. In particular, the method of the present invention is related to the observation that optimal staining is maintained when there is a stoichiometric relationship between nuclear stain uptake and chromatin content of the nucleus.

The novelty of this approach involves the ability to automatically recognize trends in certain imager derived parameters. By using this method, stain quality can be monitored by an automated cytology system.

### BRIEF DESCRIPTION OF THE FIGURES

FIG. 1. is an illustration of Distribution of Imager Derived parameters of nuclear area vs. nuclear integrated optical density (CIOD)

### SUMMARY OF THE INVENTION

The present invention generally relates a method for determining the quality of a staining solution. In particular, the method of the present invention is related to a method for evaluating stain or dye performance comprising comparing the parameters derived from an imaging based automated cytology system to characterize said stain performance.

In one aspect of the present invention, a method for evaluating stain or dye performance parameters wherein said parameters comprise the measurement of integrated optical density of normal and abnormal specimens is presented.

In another aspect of the invention, the normal and abnormal specimens are mammalian cells. In one preferred embodiment of the present invention, the mammalian cells are human cervical cell.

In yet another aspect of the present invention, the integrated optical density measurements are; Mean CIOD, Mean CV, Top 20 Median CIOD, and CIOD Ratio.

In still yet another aspect of the present invention, the nuclear stain is a stoichiometric stain. In one preferred embodiment of the present invention, the stoichiometric stains are the dyes hematoxylin, orange g, fast green, or eosin y.

In one aspect of the present invention, a method for evaluating stain or dye performance in staining processes which utilize dyes to stain cells or tissue, which comprises comparing the integrated optical density measurements derived from an imaging based automated cytology system to characterize said stain performance is presented.

### DETAILED DESCRIPTION OF THE INVENTION

Cytology is the branch of biology dealing with the study of the formation, structure, and function of cells. As applied in a laboratory setting, cytologists, cytotechnologists, and other medical professionals make medical diagnoses of a patient's condition based on visual examination of a specimen of the patient's cells. A typical cytological technique is a “Pap smear” test, in which cells are scraped from a woman's cervix and analyzed in order to detect the presence of abnormal cells, a precursor to the onset of cervical cancer.

Cell samples may be obtained from the patient by a variety of techniques including, for example, by scraping or swabbing an area, or by using a needle to aspirate body fluids from the chest cavity, bladder, spinal canal, or other appropriate area. The cell samples are placed in solution and subsequently collected and transferred to a glass slide for viewing under magnification. Fixative and staining solutions are typically applied to the cells on the glass slide, often called a cell smear, for facilitating examination and for preserving the specimen for archival purposes. The slides may then be evaluated visually by a cytotechnologist or by an automated imaging system. Cytological techniques are also used to detect abnormal cells and disease in other parts of the human body.

One prognostic indicator which has been valuable in the detection of abnormal cells in a Pap smear is DNA ploidy, which is the ratio of the quantity of DNA in a cancer cell to that in a normal cell in the resting phase of its growth cycle. In general, cells with normal resting-phase cellular DNA content (diploid) can be differentiated from those with abnormal DNA content (aneuploid). A cancer cell is aneuploid if it does not have the normal diploid number due to chromosome loss or an excess in chromosomes. “Hypoploidy” indicates loss of portions of or complete chromosomes. “Hyperploidy” or “hyperdiploidy” indicates that a cell contains more than the diploid number. Although standards vary, a chromosome number averaging at least 1.1 or 1.2 times the diploid number indicates hyperploidy or hyperdiploidy. These two latter terms partially overlap with the terms “tetraploidy” (twice the diploid number) and “hypertetraploidy” (more than twice the diploid number).

Various methods have been developed for measuring the DNA content of whole nuclei as a possible indicator of cancer including fluorescence in situ hybridization (FISH) [Marshall et al. (1996) Mutat. Res. 372:233-45; and Hande et al. (1997) Mutagenesis 12:125-31]; flow cytometry (FCM) [Stonesifer et al. (1987) Acta Cytol. 31:125-30; Remvikos et al. (1988) Int. J. Cancer 42:539-43; and Bronner et al. (1988) Am. J. Clin. Pathol. 89:764-9]; the Schutte method and the Hedley method [Tagawa et al. (1993) Cytometry 14:541-9]; Magnetic Resonance (MRI) [Takashima et al. (1996) Am. J. Roentgenol. 167:1297-304]; the stemline interpretation technique [Borchers et al. (1994) Urol. Int. 52:145-150]; and the analysis of spindle apparatus anomalies [Kochendorfer et al. (1996) Mutat. Res. 361:55-66].

Quantitative analysis, particularly the automated quantitative analysis of cytological, hematological and histological specimens requires exacting control of dyes, dye solutions and staining processes. Quantitative measurements used to differentiate normal from pathologic specimens may be expressed either as light transmission, integrated optical densities, ploidy, light scattering, light polarization effects and fluorescence. Since these measurements are strongly dependent on the staining process, a characterization and standardization of the dyes and staining solutions used is necessary.

In order to use any type of staining system with an automated imaging system, the quality, concentration and reproducibility of the stain formulation needs to be monitored to insure that the degree of staining is consistent. The conventional methods of standardizing and evaluating dyes and staining solutions includes the direct visual assessment of stain performance, however, the visual assessment of stain performance suffers from the lack of measurable parameters by which the performance can be quantitatively evaluated.

The difficulty of comparing biological samples quantitatively is due in large part to variations in the staining process. Dyes vary from batch to batch, and their performance may vary over time for the same batch or even for the same preparation. This variability is especially true for automated analysis using the staining components hematoxylin, orange g, and eosin y. Commercial suppliers of these stains all have formulations that vary to different degrees, therefore, it is necessary to develop an imaging based quality control process for determining if the functional performance of staining solutions is adequate for automated imaging.

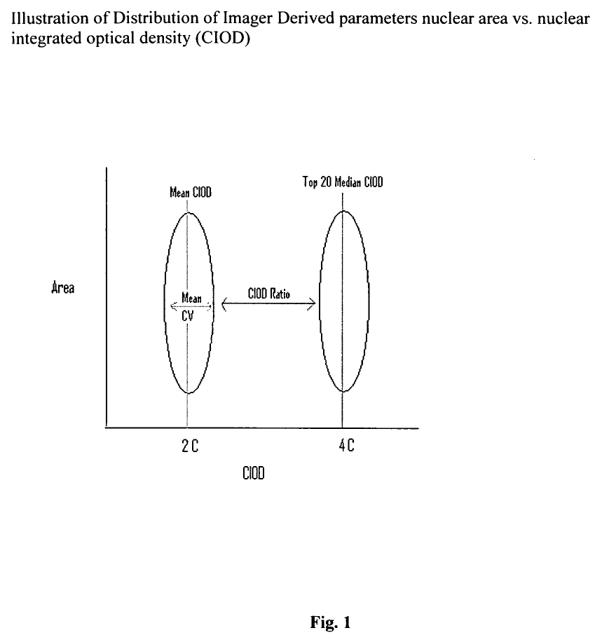

The method of the present invention makes use of method of stain quality control (stain QC) using parameters derived from an imaging based automated cytology system to characterize stain performance. The distribution of measured cells in a plot of nuclear area (on the “y” axis) vs. nuclear integrated optical density (on the “x” axis) is illustrated in FIG. 1. Several parameters have been derived to characterize this distribution. By using simple summary statistics (e.g. a running average), stain quality can be monitored.

Significance of Imager Parameters

Stoichiometric nuclear staining: Numerous imaging systems make use of measures integrated optical density (IOD), to assist in the quantification of deoxyribonucleic acid (DNA) in a cell, such as the Automated Cellular Imaging System (ACIS) (ChromaVision, San Juan Capistrano, Calif.) and the ThinPrep® Imaging System (Cytyc Corporation, Marlborough, Mass.). The staining protocol for the ThinPrep® Imager has been designed to produce approximately stoichiometric nuclear staining. When nuclear staining is stoichiometric, the corrected integrated optical density (CIOD) is directly proportional to the amount of chromatin in the nucleus.

In general, on a normal slide, most of the squamous nuclei on the slide would distribute in a “cloud” centered at the 2C point on the CIOD axis (illustrated by the oval at 2C in FIG. 1). That is, the normal or 2C amount of chromatin is present in the nuclei, and when the nuclei are stained, the nuclear dye uptake produces darkness which results in CIOD measurements that fall within the oval at 2C. On most normal slides there are also nuclei present which contain two times the 2C amount of chromatin (4C). The distribution of these nuclei is represented by the oval at 4C in FIG. 1. Abnormal cases usually also contain normal nuclei that would fall within the 2C and 4C ovals in FIG. 1. In addition, abnormal cases usually contain both abnormal nuclei that would fall within the 4C oval and abnormal nuclei that have even more chromatin so that the CIOD measurements would scatter to the right of the 4C oval along the CIOD axis.

Another characteristic of a stoichiometric nuclear stain is that there is no correlation between area and CIOD. In FIG. 1, this characteristic is illustrated by the upright orientation of the ovals at 2C and 4C. That is, for nuclei with the same chromatin content, the CIOD measurements would be the same regardless of the size (area) of the nucleus. Since the staining protocol produces approximately stoichiometric nuclear staining, there is some correlation between nuclear area and CIOD. However, a sharp tilt in the 2C or 4C ovals would indicate the presence of non-specific nuclear staining.

Imager Measurements/Classification: The ThinPrep® Imager classifies single nuclei by identifying those objects that are most likely normal nuclei or artifacts and separating them from the objects being considered for ranking. The remaining objects are ranked on the basis of CIOD. In FIG. 1, nuclei that would scatter at the right of the scatterplot (highest CIOD values) would have the highest ranking followed by the nuclei with decreasing CIOD values. Mean CIOD, Mean CV, Top 20 Median CIOD, and CIOD Ratio are Imager measures of the characteristics of the graph in FIG. 1.

Mean CIOD: Mean CIOD is averaged over objects that have been classified by the Imager as intermediate cells. This feature is represented by the green line that intersects the CIOD axis at 2C in FIG. 1. Since intermediate cells have high contrast between the nucleus and cytoplasm, the segmentation algorithm is relatively insensitive to subtle stain changes in intermediate cells. To determine stain uptake, intermediate cells are selected for calculating Mean_CIOD; the high contrast seen with intermediate cells allows the segmentation algorithm to be more accurate. Therefore, since segmentation is accurate, Mean CIOD is a good measure of stain uptake.

Mean CV: Mean CV is a descriptor of the horizontal spread of the CIOD for the 2C oval (represented by the blue arrowed line in FIG. 1). If this value gets large, nuclei that belong in the 2C oval can spread into and overlap the 4C oval, possibly causing normal cells to outrank abnormal cells. An increase in CV can be an indicator that non-specific staining has increased. That is, a high CV can indicate that the nuclear stain is binding to additional sites (e.g. non-chromatin associated sites in the nucleus, and/or sites in the cytoplasm). When this happens, there is a correlation between area and CIOD causing the 2C oval to tilt, resulting in an increase in Mean CV. Since there is no disadvantage to having a very small CV (it just indicates a very tight distribution of the 2C oval), there is no need to establish a lower limit for Mean CV.

Top 20 Median CIOD: Top 20 Median CIOD is a measure of the median CIOD of nuclei that distribute around the 4C point on the CIOD axis over a set of slides. This measurement is represented by the orange line that intersects the CIOD axis at 4C in FIG. 1. The cell types that fall into this area of the scatterplot tend to have thicker cytoplasms (e.g. squamous metaplastic cells) resulting in lower contrast between nucleus and cytoplasm than is typically seen for intermediate cells. If the Top 20 Median CIOD value is higher than the usual operating point, it may indicate poor contrast between the nucleus and cytoplasm which results in segmentation errors. If segmentation errors cause normal 4C nuclei to have falsely high CIOD values, this indicates that normal nuclei could outrank abnormal nuclei on the slide. If the Top 20 Median CIOD is lower than the usual operating point, it may indicate that the stain uptake in the nuclei is lower than optimal.

CIOD Ratio: CIOD Ratio is a measure of separation between the 2C and 4C ovals (represented by the red arrowed line in FIG. 1). If the staining is stoichiometric, the ratio of Top 20 Median CIOD/Mean CIOD should be approximately equal to 2. In other words, nuclei from the 4C oval should be approximately twice as dark as nuclei from the 2C oval because 4C nuclei have twice as much chromatin as 2C nuclei. A high CIOD Ratio could indicate segmentation errors which could cause normal 4C nuclei to outrank abnormal nuclei. A low CIOD Ratio would indicate that the 2C and 4C ovals have moved closer together which could result in normal 2C nuclei outranking abnormal nuclei.

### EXAMPLE

The above parameter have been monitored using experimental sets of pre-qualified cytology specimens for various nuclear stain lots. These experimental sets consist of a small number (5-6) slides with a variety of specimen conditions. The Mean CIOD and Mean CV parameters are measured for a set of 6 slides consisting of normal and abnormal cell pools (several individual cytology specimens are combined to make a cell pool). The Top 20 Median CIOD is measured for a set of 5 normal specimens. Summary statistics are given in Tables 1 and 2 below.

TABLE 1
“Young” stain (Nuclear Stain age <2.0 months)

| | Experi- | | | | | | |
|---|---|---|---|---|---|---|---|
| | mental | | | | | Mean − | Mean + |
| Variable | sets | Mean | StdDev | Min | Max | 3SD | 3SD |
| Top 20 | 57 | 90.3 | 4.5 | 77.2 | 102.1 | 76.8 | 103.9 |
| Median | | | | | | | |
| CIOD | | | | | | | |
| Mean CIOD | 57 | 42.2 | 1.7 | 37.8 | 44.6 | 37.1 | 47.2 |
| Mean CV | 57 | 9.8 | 0.7 | 8.3 | 11.7 | 7.7 | 11.9 |
| CIOD Ratio | 57 | 2.1 | 0.1 | 2 | 2.4 | 1.9 | 2.4 |

TABLE 2
“Mature” stain (2.0 < Nuclear Stain Age <12 months)

| | Experi- | | | | | | |
|---|---|---|---|---|---|---|---|
| | mental | | | | | Mean − | Mean + |
| Variable | sets | Mean | StdDev | Min | Max | 3SD | 3SD |
| Top 20 | 149 | 99.8 | 6.8 | 84.9 | 137 | 79.5 | 120.1 |
| Median | | | | | | | |
| CIOD | | | | | | | |
| Mean CIOD | 149 | 43.9 | 0.8 | 40.9 | 45.4 | 41.4 | 46.4 |
| Mean CV | 149 | 9.2 | 0.5 | 7.9 | 10.7 | 7.6 | 10.7 |
| CIOD Ratio | 149 | 2.3 | 0.1 | 2 | 3.1 | 1.9 | 2.7 |

Clinical performance of the imager using slides that were stained at various nuclear stain ages can be tested by assessing abnormal specimen detection rates and percent agreement for abnormal specimens by comparing imager results to manual screening results.

This was tested on over 800 clinical specimens using four different stain lots of approximate nuclear stain ages 0.5, 2, 6, or 12 months (lots D, A, B, C, respectively). Once clinical efficacy has been established, specification ranges for the imager derived parameters can be set such that any experimental condition that yielded results outside of the specifications would be considered to fail stain quality assessment. This method can be used to qualify new manufactured stain lots, new dye lots, changes in staining protocols, etc.

Automated Stain OC

If the above parameters are measured over a larger number of clinical cases, then the parameters tend to behave the same way as if they were measured over a very small set of pre-qualified specimens of specific specimen conditions. From Table 3 it can be seen that most of the measurements for nuclear stain lots A, B, and C fall within Mean+/−3 SD for “Mature” stain (Mean CV for lot C fall outside Mean+3 SD), and all measurements for nuclear stain lot D fall within Mean+/−3SD for “Young” stain. In this data set, the ratio of normal:abnormal specimens is approximately 2:1. Even with such a high proportion of abnormal specimens, the Top 20 Median CIOD which is only measured on normal cases for the experimental sets in Tables 1 and 2 falls within the Mean+/−3 SD range.

Since a 2:1 ratio of normal:abnormal represents a much higher proportion of abnormal specimens than would be expected in a usual clinical setting, it both Top 20 Median CIOD and CIOD Ration will likely be useful in a clinical setting given a sufficient sample size. With a sufficient number of clinical specimens refined thresholds for each of the parameters can be set. Simple statistical methods such as a running average can be used to monitor stain quality. If the thresholds are exceeded, a slide event would be generated by the imager indicating a stain quality issue.

TABLE 3
Summary of Imager Derived parameters for 828 cases
used to test Clinical performance

| | Approx. | | | | | |
|---|---|---|---|---|---|---|
| | Nuclear | | | | | |
| | Stain | | | | Top 20 | |
| | Age | Number of | Mean | Mean | Median | CIOD |
| Stain Lot | (mo) | Specimens | CIOD | CV | CIOD | Ratio |
| A | 2 | 198 | 42.8 | 10.7 | 92.0 | 2.1 |
| B | 6 | 208 | 43.6 | 9.8 | 97.7 | 2.2 |
| C | 12 | 202 | 43.3 | 12.4 | 115.4 | 2.7 |
| D | 0.5 | 220 | 41.0 | 10.8 | 89.3 | 2.2 |

Equivalents

Those skilled in the art will recognize, or be able to ascertain using no more than routine experimentation, many equivalents to the specific embodiments of the invention described herein. The invention can be embodied in other specific forms without departing from the spirit or essential characteristics thereof. The present embodiments are therefore to be considered in all respects as illustrative and not restrictive. The scope of the invention is indicated by the appended claims, rather than by the foregoing description, and all changes which come within the meaning and range of equivalency of the claims are therefore intended to be embraced therein.

1. A method for evaluating stain or dye performance comprising comparing the parameters derived from an imaging based automated cytology system to characterize said stain performance.

2. The method of claim 1 wherein said parameters comprise the measurement of the integrated optical density of normal and abnormal specimens.

3. The method of claim 1 wherein the specimens are cervical cells.

4. The method of claim 2 wherein the integrated optical density measurements are; Mean CIOD, Mean CV, Top 20 Median CIOD, and CIOD Ratio.

5. The method of claim 1 wherein the nuclear stain is a stoichiometric stain.

6. The method of claim 4 wherein the stain system is comprised of the dyes: hematoxylin, orange g, fast green, or eosin y.

7. A method for evaluating stain or dye performance in staining processes which utilize dyes to stain cells or tissue, which comprises comparing the integrated optical density measurements derived from an imaging based automated cytology system to characterize said stain performance.

8. The method of claim 7 wherein the specimens are cervical cells.

9. The method of claim 7 wherein the integrated optical density measurements are; Mean CIOD, Mean CV, Top 20 Median CIOD, and CIOD Ratio.

10. The method of claim 7 wherein the nuclear stain is a stoichiometric stain.

11. The method of claim 10 wherein the stain system is comprised of the dyes: hematoxylin, orange g, fast green, or eosin y.
